(19) United States
(12) Patent Application Publication
(10) Pub. No.: US 2006/0172163 A1
(43) Pub. Date: Aug. 3, 2006

(54) Fuel cell stack and fuel cell system having the same

(76) Inventors: Jun-Won Suh, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 11/182,647

(22) Filed: Jul. 14, 2005

(30) Foreign Application Priority Data
Jan. 28, 2005 (KR) 10-2005-0007919

(51) Int. Cl. H01M 8/04; H01M 8/24

(52) U.S. Cl. 429/26; 429/38

(57) ABSTRACT

There is provided a stack of a fuel cell system in which one or more electricity generators including separators disposed at both sides of a membrane-electrode assembly are stacked, the stack comprising heat releasing means for releasing heat generated from the electricity generators. The heat releasing means have different heat release rates depending on the positions of the associated electricity generators in the stack. In particular, the heat releasing means associated with the electricity generators located near the center of the stack have a higher heat release rate in order to maintain a more even temperature gradient across the stack.

### CROSS-REFERENCE TO RELATED APPLICATION

This application claims priority to and the benefit of Korean Patent Application No. 10-2005-0007919, filed on Jan. 28, 2005 in the Korean Intellectual Property Office, the entire content of which is incorporated herein by reference.

### FIELD OF THE INVENTION

The present invention relates to a fuel cell system, and more particularly to a stack of a fuel cell system with improved cooling efficiency, and a fuel cell system having the same.

### BACKGROUND OF THE INVENTION

In general, a fuel cell is an electricity generating system for directly converting chemical energy into electric energy through an electrochemical reaction between oxygen contained in air and hydrogen contained in hydrocarbon-grouped materials such as methanol, ethanol, and natural gas. Specifically, fuel cells have a feature such that electricity is generated through an electrochemical reaction between a fuel gas and an oxidizing gas without combustion and with heat as a byproduct thereof.

Such fuel cells may be classified into phosphate fuel cells working at temperatures of about 150° C. to 200° C., molten carbonate fuel cells working at high temperatures of about 600° C. to 700° C., solid oxide fuel cells working at high temperatures of 1000° C. or more, and polymer electrolyte membrane fuel cells and alkali fuel cells working at room temperature or at temperatures of 100° C. or less, depending upon the kinds of electrolyte used. All such fuel cells basically work under the same principle, but may differ from one another in the kinds of fuel, the operating temperatures, the catalysts, and the electrolytes.

Recently developed polymer electrolyte membrane fuel cells (hereinafter referred to as a PEMFCs) have excellent output characteristic, low operating temperatures, and fast starting and response characteristics compared to other fuel cells. Accordingly, PEMFCs have a wide range of applications such as for mobile power sources for vehicles, for distributed power sources for homes or buildings, and for small-sized power sources for electronic apparatuses.

A PEMFC system basically requires a fuel cell main body (hereinafter referred to as a stack for the purpose of convenience), a reformer for reforming fuel to generate hydrogen gas, a fuel tank, and a fuel pump for supplying fuel to the reformer. In a PEMFC, the fuel stored in the fuel tank is supplied to the reformer by means of pumping power of the fuel pump. Then, the reformer reforms the fuel and generates the hydrogen gas to the stack. In the stack, hydrogen gas and oxygen electrochemically react with each other, thereby generating electrical energy.

Another type of fuel cell is a direct methanol fuel cell (hereinafter referred to as a DMFC) in which liquid-state methanol fuel is supplied directly to the stack. Unlike a PEMFC, a DMFC does not require a reformer.

In the fuel cell systems described above, the stack that generates electricity has a stacked structure of several or several tens of unit cells, each of which has a membrane-electrode assembly (hereinafter referred to as an MEA) and separators (or bipolar plates). The MEA includes an anode electrode and a cathode electrode attached to either side of an electrolyte membrane. The separator simultaneously functions as a passage through which oxygen and hydrogen gas required for the reaction of the fuel cell are supplied, and as a conductor connecting the anode electrode and the cathode electrode of each MEA in series.

Through the bipolar plate, fuel gas containing hydrogen is supplied to the anode electrode and oxygen gas containing oxygen is supplied to the cathode electrode. An oxidation reaction of the fuel gas takes place in the anode electrode and a reduction reaction of the oxygen gas takes place in the cathode electrode. Due to movement of electrons, electricity, heat, and water can be produced simultaneously.

In such a fuel cell system, when the operating temperature deviates from an appropriate range, the performance of the electrolyte membrane deteriorates and safety thereof cannot be ensured. Furthermore, in a serious case, the fuel cell may be damaged. Therefore, a cooling means using air or water is often provided within the fuel cell system in order to continuously remove heat generated inside the stack when operating the fuel cell system.

However, the adaptation of the same cooling scheme to all parts of the stack in a conventional cooling scheme makes it difficult to effectively cool all unit cells of a stack which may have substantially different temperature distributions depending on their positions within the stack.

Specifically, a unit cell located at a central portion among unit cells of the stack tends to have a temperature that is higher than that of a unit cell located near either end of the stack.

In the conventional fuel cell system, since heat generated in each of the stacked unit cells is not uniformly released, the performance of the stack deteriorates, thereby decreasing the overall efficiency of the fuel cell system.

### SUMMARY OF THE INVENTION

The present invention is directed to a fuel cell system that is capable of quickly releasing heat generated from the entire stack and of uniformly maintaining the temperature of the entire stack within an appropriate range by changing the heat-emission structure depending on location within the stack.

According to the present invention, a fuel cell stack and a fuel cell system are provided that are capable of uniformly maintaining temperature distribution throughout the entire stack by quickly absorbing heat locally generated in the stack.

According to one embodiment of the present invention, a fuel cell stack is provided, the stack comprising an electricity generating unit including a plurality of unit cells, and a cooling unit supplying specific unit cells with coolant to correspond to differences in heat-emission depending on the different positions of each of the unit cells.

According to the invention, the electricity generating unit may generate more heat toward a central portion of the stack, so the cooling unit may provide an increased amount of coolant toward a central portion of the stack.

According to another embodiment of the present invention, a stack of a fuel cell is provided in which one or more electricity generators including separators disposed at both sides of a membrane-electrode assembly (MEA) are stacked, the stack comprising a heat releasing means for releasing heat generated from each electricity generator, wherein the heat releasing means have different heat release rates depending on the positions of the electricity generators in the stack.

In general, the heat releasing means are constructed such that the heat release rate of the electricity generator increases toward a central portion of the stack.

According to such a construction, since the temperature of an electricity generator located at a central portion of the stack tends to be higher than those of the electricity generators located at the outer portions thereof, the heat release rates of the heat releasing means located near the central portion of the stack are higher than those of the heat releasing means located at the outer portions. Therefore, the heat generated at the central portion of the stack can be quickly released and the temperature of the entire stack can be uniformly controlled.

According to one embodiment, the heat releasing means includes flow passages which are formed in the separators and through which a coolant flows. The heat release rate may be varied by varying the sizes of the flow passages depending on the positions of the electricity generators within the stack.

According to another embodiment, the heat releasing means may include cooling plates with holes through which coolant may flow. The size of the holes may be varied to vary the heat release rate.

According to yet another embodiment, the heat releasing means may include flow grooves which are formed in separators at portions corresponding to non-active regions of the MEA and through which coolant flows. The heat release rate may be varied by making the size of each of the flow grooves different depending on the positions of the electricity generators within the stack.

According to still another embodiment, the heat releasing means may optionally include heat conductive media which are attached to the separators and which have heat conductivity that is higher than those of the separators. The heat release rates may be varied by making the size of each of the heat conductive media different depending on the positions of the electricity generators within the stack.

According to yet another embodiment, the heat releasing means may include fans for directing cooling air to the electricity generators. The heat release rates may be varied by varying the amount of cooling air provided to the different electricity generators within the stack. This can be done by varying the number of fans or the sizes of the fans at different locations in the stack. Alternatively, the output from individual fans can be varied such as by changing the pitch of the fan blades of certain fans, or by changing the speeds of certain fans.

According to still another embodiment of the invention, a fuel cell stack is provided in which one or more electricity generators including separators disposed at both sides of an MEA are stacked. For this embodiment, flow passages through which coolant flows are formed in the separators, and the sizes of the flow passages are varied depending on the positions of the electricity generators. In this embodiment, the flow passages are formed at side surfaces of separators not opposing the MEA. Further, each of the flow passages may generally be formed in the shape of a channel or a hole.

When the flow passages are formed in the shape of a channel, a part of the channel is formed at one surface of the separator and a part of the channel is formed at one surface of another adjacent separator disposed opposite to and adhered to the separator. By such a construction, two channels are joined to become one hole.

In general, the sizes of the flow passages formed in the electricity generators located at the central portion are relatively larger than those of the flow passages of the electricity generator located at the outer sides of the stack.

The flow passages may have a cross section in the shape of a tetragon or circle, but they are not limited to any specific shape.

According to still another embodiment of the present invention, a fuel cell stack is provided in which one or more electricity generators including separators disposed at both sides of an MEA are stacked, cooling plates are disposed between the electricity generators, holes through which coolant may flow are formed in the cooling plates, and the sizes of the holes formed in the cooling plates are varied depending on the positions of the electricity generators.

It is preferable that the size of the hole formed in the electricity generator located at a central portion is relatively larger than that of the hole formed in the electricity generator located at the outer sides.

The flow passages may have a cross section in the shape of a tetragon or a circle, but they are not limited to any specific shape.

According to another aspect of the present invention, there is provided a stack of a fuel cell in which one or more electricity generators including separators disposed at both sides of an MEA are stacked, flow grooves through which coolant flows are formed in separators at portions corresponding to non-active regions of the MEA, and the sizes of the flow grooves are varied depending on the positions of the electricity generators.

Here, the non-active region means a region through which air or hydrogen gas does not flow and in which the hydrogen gas does not react with the air.

The flow grooves form one or more flow lines between the MEA and the separator when they are stacked, and the coolant flows along these flow lines.

Further, the flow grooves are not especially limited to any specific positions in the separators if they are formed in a region other than a region to which hydrogen gas or air is supplied, and preferably are formed in the whole region outside the region to which hydrogen gas or air is supplied.

According to another aspect of the present invention, a stack of a fuel cell is provided in which one or more electricity generators including separators disposed at the sides of an MEA are stacked, heat conductive media having higher heat-conductivity than that of the separator are attached to the separators, and the size of each of the heat conductive media is made different depending on the positions of the electricity generators.

Here, the heat conductive media may be made of a heat-conductive material. Suitable examples are metal plates made from a metal such as aluminum, copper, and iron.

The heat conductive media may be attached to one side surface of each of the separators or inserted into the separators as one layer. Further, one or more heat conductive media may be inserted into the separators at a predetermined distance as a plurality of layers.

The heat conductive media may optionally have one or more holes which are formed in a central portion of the heat conductive media to be connected to a coolant supply unit and through which a coolant flows.

Where holes are formed in the heat conductive media, the size of each of the holes may be made different depending on the positions of the electricity generators within the stack. The holes may be formed in the shapes of channels.

According to another embodiment of the present invention, a stack of a fuel cell is provided in which one or more electricity generators including separators are disposed at both sides of an MEA. Fans are provided for directing cooling air to the electricity generators. The amount of cooling provided to different electricity generators can be varied by varying the amount of cooling air provided to the different electricity generators within the stack. This can be done by varying the number of fans or the sizes of the fans at different locations in the stack. Alternatively, the output from individual fans can be varied such as by changing the pitch of the fan blades of certain fans, or by changing the speeds of certain fans.

According to this embodiment, the fans may be disposed at a housing constituting the external frame of the stack. Here, the stack may be assembled by use of separators disposed at its outermost sides as end plates or by using additional end plates. The stack may use cooling air, cooling water, or some other coolant as the coolant supplied to the heat releasing means.

According to another embodiment of the present invention, a fuel cell system comprises: a stack in which one or more electricity generators including separators disposed at both sides of an MEA are stacked; a fuel supply unit for supplying hydrogen-containing fuel to the electricity generators; an air supply unit for supplying air to the electricity generators; and a coolant supply unit for supplying a coolant to the electricity generators. The stack includes heat releasing means for releasing heat generated from each electricity generator as described in the various embodiments above, and the heat release rate is made different depending on the positions of the electricity generators.

In general, the heat release rate of the heat releasing means located at a central portion is larger than that of the heat releasing means located at the outer side.

The fuel cell system may further comprise a reformer which reforms fuel supplied from the fuel supply unit to generate hydrogen gas. The fuel cell system may employ a PEMFC scheme or may employ a DMFC scheme.

The fuel cell system may employ any one of a number of different coolants including air and water.

### BRIEF DESCRIPTION OF THE DRAWINGS

The above and other features and advantages of the present invention will become more apparent by describing in detail exemplary embodiments thereof with reference to the attached drawings, in which:

FIG. 1 is a schematic diagram illustrating the entire structure of a fuel cell system according to an embodiment of the present invention;

FIG. 2 is an exploded perspective view illustrating a stack of a fuel cell system according to an embodiment of the present invention;

FIG. 3 is an exploded perspective view illustrating a stack according to another embodiment of the present invention;

FIG. 4 is an exploded perspective view illustrating a stack according to another embodiment of the present invention;

FIG. 5 is an exploded perspective view illustrating a stack according to another embodiment of the present invention;

FIG. 6 is an exploded perspective view illustrating a stack according to another embodiment of the present invention;

FIG. 7 is a schematic diagram illustrating a heat emission structure for the stack shown in FIG. 2;

FIG. 8 is a schematic diagram illustrating a heat emission structure for the stack shown in FIG. 3;

FIG. 9 is a schematic diagram illustrating a heat emission structure for the stack shown in FIG. 4;

FIG. 10 is a schematic diagram illustrating a heat emission structure for the stack shown in FIG. 6; and

FIG. 11 is a schematic diagram illustrating a heat emission structure for a stack according to another embodiment of the present invention.

### DETAILED DESCRIPTION

Hereinafter, embodiments of the present invention will be described in detail with reference to the accompanying drawings such that the embodiments can be easily put into practice by those skilled in the art. However, since the present invention can be embodied in various forms, the present invention is not limited to the embodiments described below.

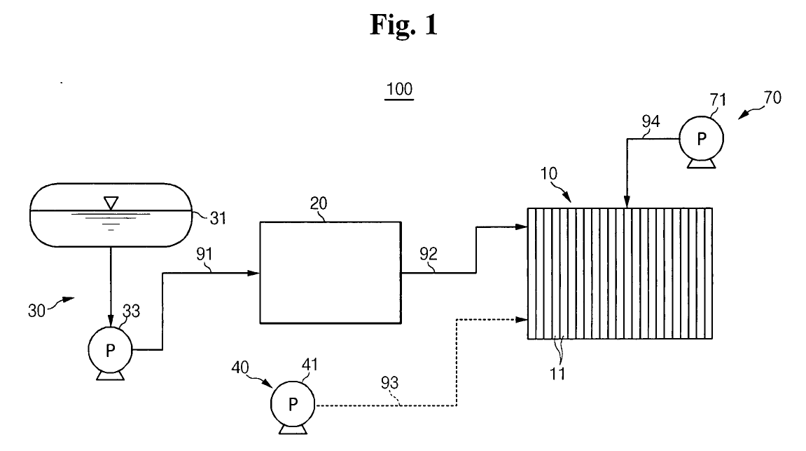

FIG. 1 is a schematic diagram illustrating a structure of a fuel cell system according to an embodiment of the present invention.

Referring to FIG. 1, the fuel cell system 100 according to the present invention comprises a stack 10 in which a number of electricity generators 11 for converting chemical energy into electric energy through a chemical reaction between hydrogen and oxygen are stacked, a fuel supply unit 30 for supplying the hydrogen-containing fuel to the electricity generators 11, an air supply unit 40 for supplying air to the electricity generators 11, and a coolant supply unit 70 for supplying a coolant to the stack 10 in order to control the temperature of the electricity generators 11.

The fuel supply unit 30 includes a fuel tank 31 in which a hydrogen-containing liquid-fuel is stored, and a fuel pump 33 connected to the fuel tank 31 to discharge the stored fuel to the stack 10 through an optional reformer 20 disposed between the fuel supply unit 30 and the stack 10. The reformer 20 is connected to the fuel supply unit 30 via a first supply line 91, and to the stack 10 via a second supply line 92.

When the fuel cell system of the present invention employs a DMFC scheme for supplying liquid fuel directly to a stack to generate electricity, the reformer is excluded, unlike in the above-mentioned PEMFC scheme. Hereinafter, the present invention will be described with reference to a fuel cell system employing the PEMFC scheme which employs the reformer 20, but the present invent is not limited to the PEMFC scheme.

The reformer 20 generates hydrogen gas from the liquid fuel, which is required for generating electricity at the stack, and reduces the concentration of CO contained in the hydrogen gas. Generally, the reformer 20 includes a reforming section for reforming the liquid fuel to generate hydrogen gas, and a CO concentration reducing section for reducing the concentration of CO. The reforming section converts the fuel into reformed gas rich in hydrogen through a catalytic reaction such as steam reformation, partial oxidation, autothermal reaction. The CO reducing section reduces the concentration of CO in the reformed gas using a catalytic reaction such as a water-gas shift method, a preferential oxidation method, etc., or purification of hydrogen using a separating membrane.

In this embodiment, the fuel includes hydrocarbon fuels, which can be easily loaded and stored. Examples include methanol, ethanol, natural gas, etc. The fuel may further include a mixture of water and a hydrocarbon fuel such as methanol, ethanol, natural gas, etc. Hereinafter, methanol, ethanol, and natural gas are referred to as “liquid fuels” for the purpose of convenience.

Pure oxygen gas stored in an additional storage unit or external air containing oxygen may be used as an oxygen source. Hereinafter, for convenience, the invention will be described with reference to an example in which external air is used, however, the invention is not so limited.

The air supply unit 40 includes an air pump 41 which is connected to the stack 10, and which draws in external air and supplies it to the stack 10. The stack 10 is connected to the air supply unit 40 through a third supply line 93.

Further, the coolant supply unit 70 includes a pump 71 which draws in a coolant and produces the coolant to the stack 10 through a fourth supply line 94. Any one of a number of different coolants may be used. Examples include cooling water which can be provided in either a liquid phase or a gaseous phase. In this embodiment, however, it will be described with reference to an example in which air is used as the coolant, which can be easily obtained in nature.

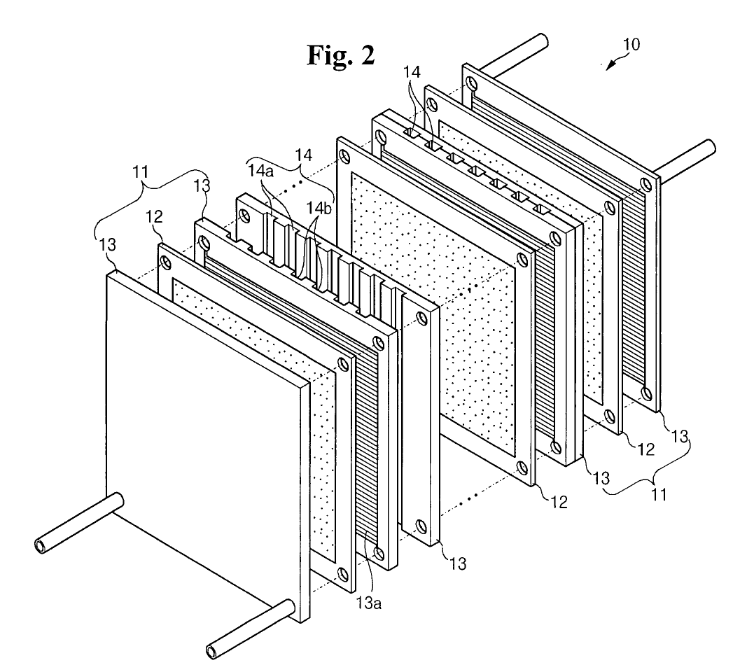

Next, in the fuel cell system having the described structure, the stack 10 which generates electricity using fuel and air supplied from the fuel supply unit 30 and the oxygen supply unit 40 is cooled using a coolant supplied from the coolant supply unit 70 will be described with reference to FIGS. 2 to 5.

FIG. 2 illustrates the stack according to the present embodiment. The stack 10 includes a plurality of electricity generators 11 which are supplied with hydrogen gas reformed through the reformer 20 and external air, and which generate electricity through an oxidation and reduction reaction.

Each of the electricity generators 11 is a unit cell for generating electricity.

The electricity generators 11 include an MEA 12 which oxidizes/reduces hydrogen gas and air, and separators 13 which supply hydrogen gas and air to the MEA 12.

Each of the electricity generators 11 is constructed such that the separators 13 are disposed at both sides of the MEA 12, and the separators 13 are attached to the MEA 12. The stack 10 is comprised of the plurality of electricity generators 11 successively disposed.

The MEA 12 is generally constructed such that an electrolyte membrane is disposed between an anode electrode and a cathode electrode which constitute both side surfaces of the MEA 12. The anode electrode is supplied with reformed gas through the separator 13. The anode electrode includes a catalytic layer separating reformed gas into electrons and hydrogen ions, and a gas diffusion layer for smooth movement of the electrons and the reformed gas. The cathode electrode is supplied with air through the separator 13. The cathode electrode includes a catalytic layer for forming water by a reaction of the electrons, the hydrogen ions and hydrogen of the air, and a gas diffusion layer for smooth movement of the electrons and the oxygen. The electrolyte membrane is made of a solid polymer electrolyte having a thickness of 50 to 200 μm and functions to move hydrogen ions generated at the catalytic layer of the anode electrode to the catalytic layer of the cathode electrode.

The separators 13 function to serially connect the anode electrode to the cathode electrode and to provide passages for supplying hydrogen gas and air required for the oxidation and reduction reactions of the MEA 12 to the anode and cathode electrodes. The separators 13 have flow channels 13a formed on the surfaces thereof to supply gas required for the oxidation and reduction reaction of the MEA 12.

More specifically, the separators 13 are disposed at both sides of the MEA 12 with the MEA 12 interposed therebetween, and are closely attached to the anode and cathode electrodes of the MEA 12. The separators 13 have flow channels 13a formed on the surface closely attached to the anode and cathode electrodes of the MEA 12. The flow channels 13a supply hydrogen gas to the anode electrode and supply air to the cathode, respectively.

The stack 10 having the above-mentioned configuration generates electricity and water through a reaction such as in the following equations.
Anode reaction: H₂→2H⁺+2e⁻
Cathode reaction: ½O₂+2H⁺+2e⁻→H₂O
Total reaction: H₂+½O₂→H₂O+current+heat

Referring to the equations, hydrogen gas and air are supplied to the anode and cathode electrodes of the MEA 12 through the separator 13, respectively. When the hydrogen gas flows through the anode electrode, hydrogen is decomposed into electrons and protons (hydrogen ions) at the catalytic layer. When protons move through the electrolyte membrane, electrons, oxygen, and protons are reacted together and water is generated at the cathode electrode with the help of a catalytic agent. Here, electrons generated at the anode electrode cannot move through the electrolyte membrane and move to the cathode electrode through an external circuit. Through such a process, electricity and water are generated, and heat as a byproduct is generated at the stack 10 through a chemical reaction between the hydrogen gas and oxygen.

During operation of the stack 10, heat is generated from each electricity generator 11. The coolant supply unit 70 is operated to remove the heat generated from each electricity generator 11. According to this embodiment, the coolant supply unit 70 supplies cooling air to the stack 10.

In the stack 10 according to the present embodiment, the temperature of the entire stack 10 is suitably maintained by circulating the cooling air supplied from the coolant supply unit 70 through the inside of the stack 10. To do so, flow passages 14 through which air flows are formed in the separators 13.

The sizes of the flow passages 14 are varied depending on the positions of the electricity generators 11 within the stack 10. In general, the sizes of the flow passages 14 increase from the outside ends of the stack 10 toward the central portion of the stack 10.

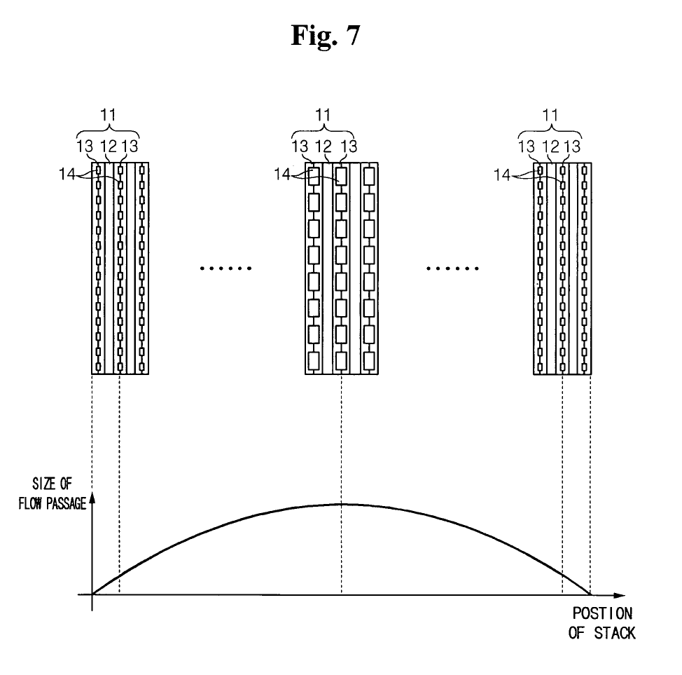

FIG. 7 illustrates the differences in sizes of the flow passages 14 depending on the positions of the respective separators within the stack 10. In FIG. 7, a plurality of electricity generators 11 including the MEA 12 and the separators 13 are stacked to form the stack 10. The sizes of the flow passages 14 increase toward a central portion of the stack 10 from both side surfaces.

Here, the differences in sizes between the flow passages located at the outermost right or left side and the flow passages located at a central portion is not limited to any specific value.

Here, the size of the flow passage 14 means an individual sectional area of each of the flow passages 14 formed on one separator 13, or the sum of the sectional areas of the all flow passages 14 formed on one separator 13. The sectional area can be defined as a sectional area which substantially determines the flow rate.

In this embodiment of the present invention, the sizes of the flow passages 14 are different because the heat-emission temperatures of the electricity generators 11 located at a central portion of the stack 10 tend to be higher than those of the electricity generators 11 located at the sides when operating the fuel cell system. When cooling air is supplied to the stack 10 from the coolant supply unit 70 through the flow passages 14, a greater amount of cooling air can be supplied to the electricity generator located at a central portion of the stack 10 compared to one located nearer the outer sides of the stack 10, thereby increasing cooling effect.

Here, the flow passages 14 include a plurality of channels 14a and 14b formed at side surfaces opposite to side surfaces on which the flow channels 13a are formed. In the present embodiment, the flow passages 14 are constructed such that channels 14a formed on one separator 13 of one electricity generator 11 and channels 14b formed on one separator 13 of another electricity generator 11 opposite to each other are joined together.

The temperature of the stack 10 can be lowered by releasing heat generated from each electricity generator 11 by the action of cooling air supplied from the coolant supply unit 70 through the flow passages 14 formed by the channels 14a and 14b.

As mentioned above, since the sizes of the flow passages 14 are made different depending on the positions of the electricity generators within the stack 10, a greater amount of air is supplied to a central portion of the stack 10 compared to the outer sides, whereby more heat can be removed from the central portion of the stack. Therefore, it is possible that a uniform temperature distribution can be obtained through the entire region of the stack 10.

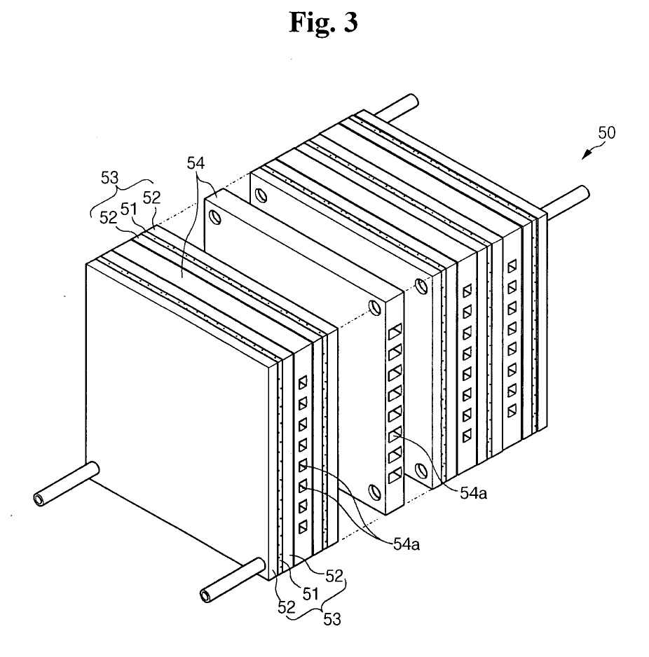

FIG. 3 illustrates a stack according to another embodiment of the present invention which employs cooling plates.

As shown in FIG. 3, electricity generators 53 including separators 52 which are disposed at both sides of MEAs 51 and which are attached to the MEAs 51 are successively stacked within a stack 50. Cooling plates 54, which have holes 54a through which air flows for cooling down the stack 50 are disposed between the electricity generators 53. The sizes of the holes 54a formed in the cooling plates 54 increase toward a central portion from the outer side depending on the stacked positions of the electricity generators 53 within the stack 50.

When the fuel cell system 100 shown in FIG. 1 employs the stack 50, cooling air supplied from the coolant supply unit 70 flows through the holes 54a formed in the cooling plates 54, whereby the temperature of the entire stack 50 can be maintained uniformly.

The sizes of the holes 54a formed in the cooling plate 54 increase toward a central portion of the stack 50 from the outer side, so the stack 50 can be effectively cooled down corresponding to heat-emission conditions that vary depending on the locations of the electricity generators 53 within the stack 50.

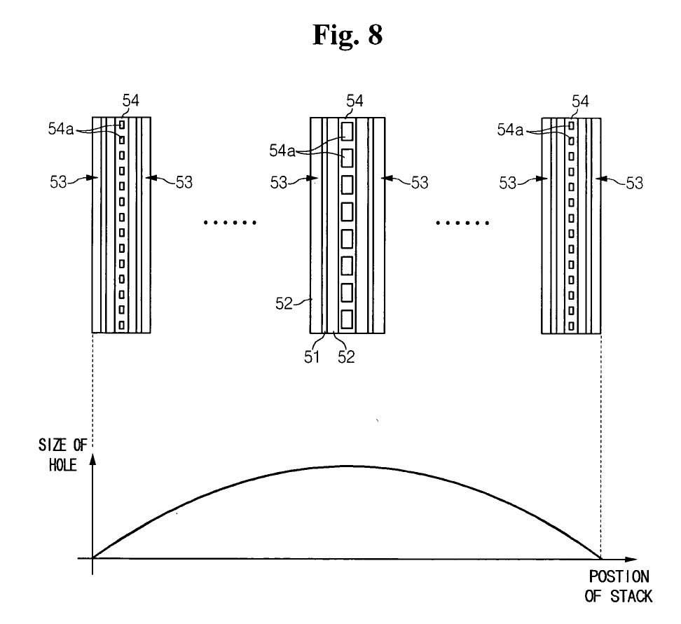

FIG. 8 illustrates the differences in sizes of the holes 54a formed in the cooling plates 54 depending on the positions in the stack 50. The stack 50 is constructed such that the cooling plates 54 are interposed between the electricity generators 53 including the MEA 51 and separators 52. The sizes of the holes 54a formed in the cooling plates 54 increase toward a central portion of the stack 50 from both side surfaces.

Here, the differences in sizes between the holes located at the outermost sides and the holes located at the central portion are not limited to any specific value.

Further, the size of the hole 54a means the individual sectional areas of the holes 54a formed in one cooling plate 54, or the sum of the sectional areas of the all holes 54a formed in one cooling plate 54. The sectional area can be defined as a sectional area which substantially determines the flow rate.

The cooling plates 54 may be formed with the same area or plate thickness through the entire stack 50, irrespective of the size of the holes 54a that vary depending on the position in the stack 50, or may be formed with different areas or thicknesses corresponding to the size of the holes 54a that vary depending on their position in the stack 50.

The separator 52 may be made of graphite, and it is preferable that the cooling plate 54 be made of a material with higher heat conductivity than that of the separator 52. Suitable materials include aluminum, copper, and iron.

According to this embodiment, it is noted that more heat tends to be generated from the electricity generators 53 toward a central portion of the stack 50. Therefore, the holes 54a having different sizes as mentioned above are formed in the cooling plates 54 disposed between the electricity generators 53 to achieve a greater amount of cooling at the central portions of the stack 50 through the holes 54a. Therefore, an electricity generator 53 located at the central portion of the stack can quickly release a greater amount of heat compared to an electricity generator 53 located at the outer side. Accordingly, it is possible to obtain a more uniform temperature distribution through the entire stack 50.

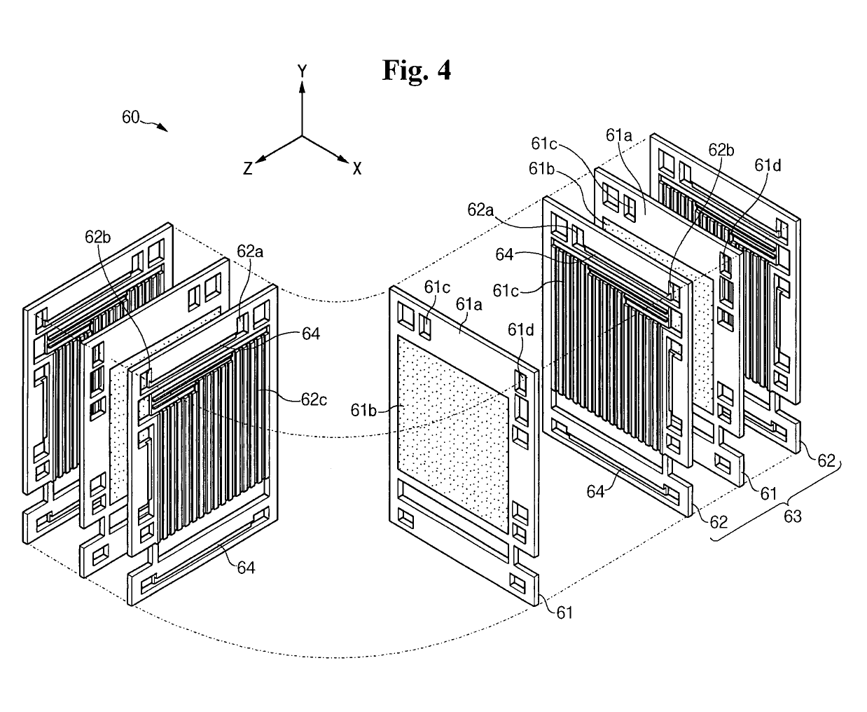

FIG. 4 illustrates a stack according to another embodiment of the present invention. As shown in FIG. 4, a stack 60 is constructed such that one or more electricity generators 63, each including separators 62 disposed at both sides of an MEA 61, are stacked.

Flow grooves 64 through which a coolant such as cooling air flows are formed in the separators 62 at portions corresponding to non-active regions 61a of the MEA 61, and the size of each of the flow grooves 64 is made different depending on its location within the stack 60.

The flow grooves 64 form passages between the separators 62 and the MEAs 61 adhered to the separators 62 through which the coolant such as cooling air is circulated to remove heat generated from the electricity generators 63.

The sizes of the flow grooves 64 increase toward a central portion of the stack 60 from the outer sides.

The non-active region 61a is a region other than an active region 61b, the active region 61b being the region through which air or hydrogen gas flows. That is, the non-active region 61a is the region where hydrogen gas and air do not react.

In the stack 60 shown in FIG. 4, the active region 61b is formed at a central portion of the MEA 61, and the non-active region 61a is formed on the periphery of the active region 61b to surround it. The flow grooves 64 are formed at positions corresponding to the non-active regions 61a, that is, at the upper and lower sides of the separator in the figure.

The position in which the flow groove 64 is formed is not especially limited as long as it is formed at a non-active region other than an active region to which hydrogen or air is supplied, and it is preferable that the flow groove 64 is formed through all regions other than the active region.

The flow groove 64 may be formed in the shape of channel, and is connected to coolant supply opening 62a and coolant discharge opening 62b.

A coolant such as cooling air is supplied through the supply opening 62a and flows through the flow groove 64 of the separator 62, and is circulated out through the discharge opening 62b.

As mentioned above, since a plurality of electricity generators 63 are stacked to construct the stack 60, the supply and discharge openings 62a and 62b formed at each of the separators 62 are formed at the same positions, and supply and discharge openings 61c and 61d are formed in the MEA 61 disposed between the separators 62 at positions corresponding to the supply and discharge openings 62a and 62b, thereby forming one supply opening and one discharge opening.

Reference numeral 62c indicates flow channels formed at the active region of the separator 62 to supply hydrogen and oxygen to the MEA 61.

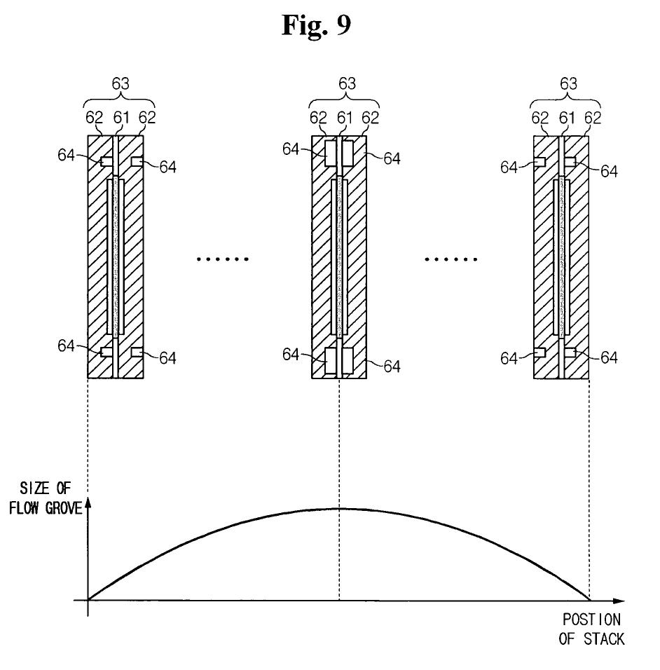

As shown in FIG. 9, a plurality of electricity generators 63 including the MEA 61 and the separators 62 are stacked to constitute the stack 60, and the sizes of the flow grooves 64 formed on the separators 62 increase toward a central portion of the stack 60 from both sides thereof.

Here, the difference in size between the flow grooves 64 located at the outermost side of the stack 60 and the flow grooves 64 located at a central portion of the stack 60 is not limited to any specific value.

Further, the size of the flow groove 64 may be considered as a sectional area or a volume of passage formed by the flow groove 64 and the MEA 61 which is disposed at the outside of the flow groove 64 and is attached to the separator 62.

According to this embodiment, it is noted that the amount of heat generated from each electricity generator 63 increases toward a central portion of the stack 60. Therefore, the flow grooves 65 having different sizes as mentioned above are formed on the separators 62, whereby a greater amount of cooling air is supplied to the electricity generators 63 located at a central portion of the stack 60 through the flow grooves 64. Therefore, the electricity generator 63 located at the central portion of the stack can quickly release a greater amount of heat compared to the electricity generator 63 located at the outer side. Therefore, it is possible to obtain a uniform temperature distribution through the entire stack 60.

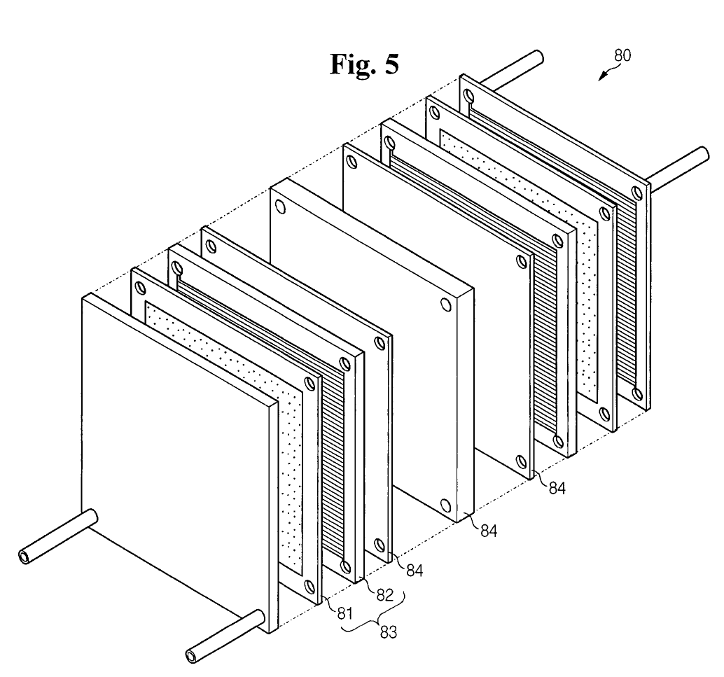

FIG. 5 illustrates a stack according to another embodiment of the present invention, in which separators employ a heat conductive medium.

As shown in FIG. 5, a plurality of electricity generators 83 including separators 82 disposed at both sides of an MEA 81 are stacked to constitute a stack 80.

A metal plate 84 having higher heat-conductivity than that of the separator 82 is attached to each separator 82, and the sizes of the metal plates 84 are different depending on the positions of the electricity generators 83 within the stack 80. That is, the thicknesses of the metal plates 84 become larger toward a central portion of the stack 80 from the outer sides.

According to this configuration, heat generated from the electricity generators 83 is quickly absorbed and released by the metal plates 84 that have higher heat-conductivity than those of the separators 82, so the stack 80 can release heat more quickly compared to another stack including only the separators 13. Further, since the thickness of the metal plates 84 positioned at the central position of the stack 80 are greater than those of the metal plates 84 positioned at the outer side, the stack 80 can effectively release more heat from the thicker plates, whereby a uniform temperature distribution can be maintained throughout the entire region.

In the present embodiment, the metal plate 84 is formed in the shape of a thin plate and is disposed at an outer side surface of the separator 82, that is, at a surface opposite to a surface in contact with the MEA 81. The thicknesses of the metal plates 84 are not limited to any specific values.

The separator 82 may be made of graphite. It is preferable that the metal plates 84 are made of a material which has higher heat-conductivity than that of the separator 82. Exemplary materials include aluminum, copper, and iron.

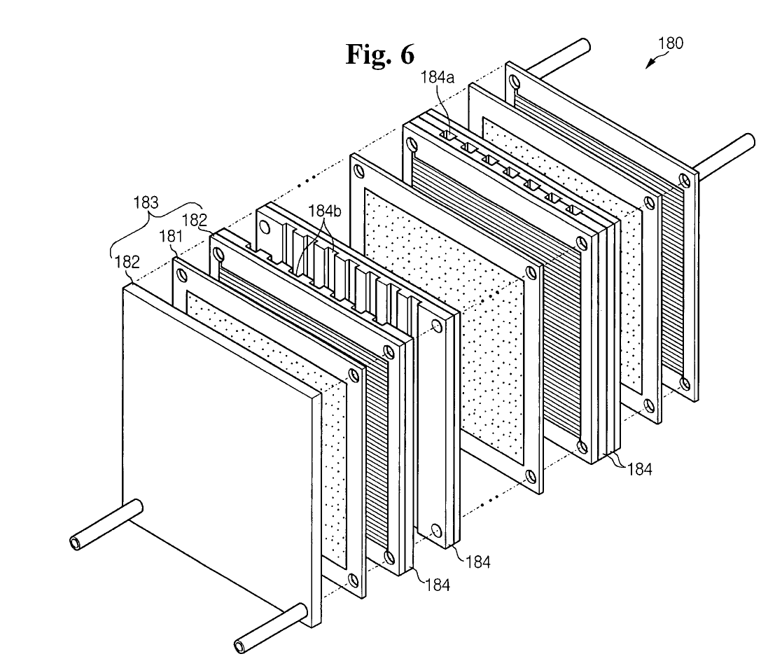

Further, the metal plate 84 may optionally have a plurality of holes through which a coolant such as cooling air may be supplied from the coolant supply unit in order to enhance the heat-emission effect. Such an embodiment is illustrated in further detail in FIG. 6.

As shown in FIG. 6, the stack 180 is constructed such that the metal plates 184, which are made of a heat conductive medium, are disposed between the electricity generators 183. Holes 184a are formed on each metal plate 184. The size of each of the holes 184a increases toward a central portion of the stack 180 from the outer sides, depending on the position of the electricity generators 183 within the stack 180. Here, the thickness of each of the metal plates 184 may be the same, or may be different as shown in FIG. 5.

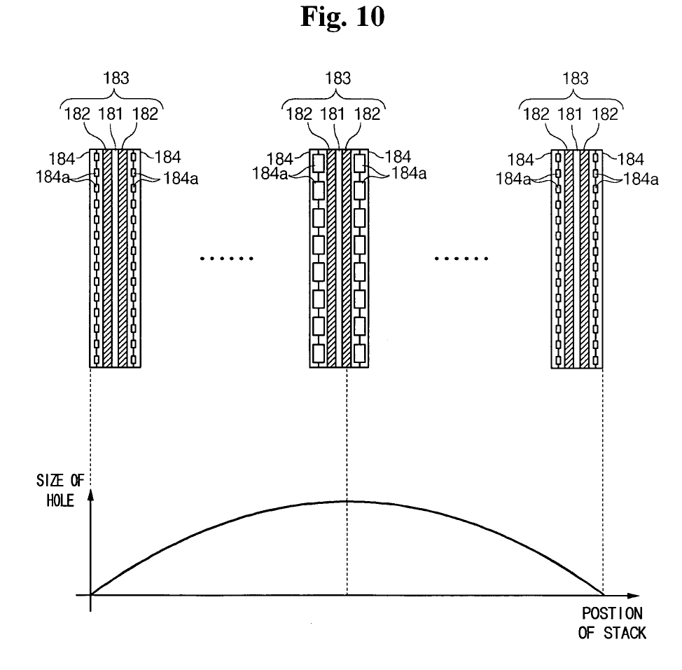

FIG. 10 illustrates the differences in the sizes of the holes 184a depending on their position within the stack 180 shown in FIG. 6. As shown in FIG. 10, a plurality of electricity generators 183 including MEAs 181 and separators 182 are stacked to constitute the stack 180, and the sizes of the holes 184a formed on the metal plates 184 attached to the separators 182 increases toward a central portion of the stack 180 from both sides thereof.

Here, the difference in size between the holes 184a formed in the metal plate 184 located at the outermost side of the stack 180 and the holes 184a formed in the metal plate 184 located at a central portion are not limited to any specific values.

Further, the size of the holes 184a may be considered to be an individual sectional area of each of the holes 184a formed in any one of the metal plates 184 or the sum of sectional areas of all the holes 184a formed in any one of the metal plates 184.

According to this embodiment, it is noted that the amount of heat generated from the electricity generator 183 increases toward a central portion of the stack 180. Therefore, holes 184a having different sizes as mentioned above are formed on the metal plates 184, so a greater amount of cooling air is supplied to the electricity generators 183 located at a central portion of the stack 180 through the holes 184a. Therefore, the electricity generator 183 located at the central portion of the stack 180 can release a greater amount of heat compared to the electricity generators 183 located at the outer sides.

In this embodiment, channels 184b formed in a metal plate 184 corresponding to any one of electricity generators 183, and channels 184b formed in a metal plate 184 corresponding to an adjacent electricity generator 183 are joined together while both the metal plates 184 are closely adhered to each other to construct the stack 180 in which the holes 184a are formed.

The coolant such as cooling air removes the heat generated from the electricity generators 183 by releasing the heat outside after it passes through the holes 184a.

As mentioned above, the size of each of the holes 184a in the stack 180 is made different depending on its position within the stack 180, and a greater amount of air is supplied to the metal plate 184 located at a central portion of the stack 180 than those located at the outer sides. Therefore, more heat generated at the central portion of the stack 180 can be removed, providing a uniform temperature distribution throughout all the regions of the stack 80.

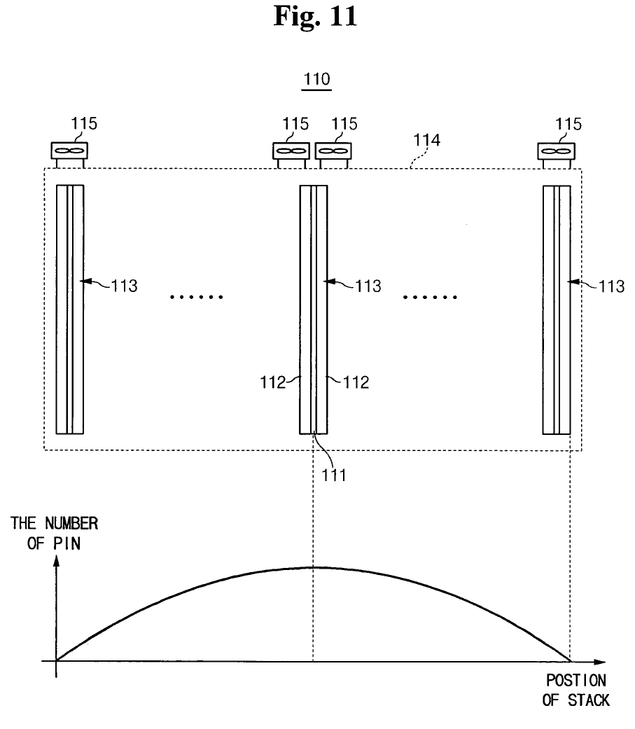

FIG. 11 illustrates a heat-emission structure of a stack according to still another embodiment of the present invention.

As shown in FIG. 11, one or more electricity generators 113 including separators 112 disposed at both sides of an MEA 111 are stacked in a stack 110, and the stack 110 includes a plurality of fans 115 which are disposed at a housing 114 surrounding the stacked electricity generators 113 and which direct a coolant (for example, cooling air) to the electricity generators 113. The amount of cooling air provided to the different electricity generators within the stack can be varied such as by varying the number of fans or the sizes of the fans at different locations in the stack. Alternatively, the output from individual fans can be varied such as by changing the pitch of the fan blades of certain fans, or by changing the speeds of certain fans.

According to the embodiment shown, the number of fans may be varied depending on the positions of the electricity generators 113 within the stack 110. The number of fans 115 increases toward a central portion of the stack 110 from the outer side thereof to correspond to the increased amount of heat generated by the electricity generators 113 at this location.

According to this configuration, cooling air supplied to the stack 110 from the coolant supply unit 70 (shown in FIG. 1) is directed in greater quantities toward the electricity generator located at a central portion of the stack than toward the electricity generator located at the outer side, whereby the electricity generator 113 showing a high temperature distribution at the central portion of the stack 110 can be effectively cooled down. Therefore, it is possible to maintain a uniform temperature distribution throughout all the regions of the stack 110.

The difference between the number of fans 115 located at the outermost position of the stack 110 and the number of fans 115 located at a central position of the stack 110 is not limited to any specific value.

According to the present embodiment, the number of fans 115 corresponding to the electricity generators 113 disposed at corresponding positions is made different depending on the position of the electricity generators 113 within the stack 110, such that air supplied to the stack 110 from the coolant supply unit 70 is directed in large quantities toward the central portion of the stack 110. Therefore, the heat of the electricity generator 113 located at the central portion of the stack 110 can be lowered more than the heat of the electricity generator 113 located at the outer side, whereby a uniform temperature distribution can be obtained throughout all the regions of the stack 110.

According to the present invention described above, the temperature of the stack at a central portion thereof can be significantly lowered, such that it is possible to have a uniform temperature distribution through the entire stack and to maintain the temperature of the stack at an appropriate level.

Further, the cooling effect of the stack can be enhanced by changing the flow rate of the coolant depending on the amount of heat generated corresponding to location within the stack.

Although exemplary embodiments of the present invention have been described, the present invention is not limited to the exemplary embodiments, but may be modified in various forms without departing from the scope of the appended claims, the detailed description, and the accompanying drawings of the present invention. Therefore, it is natural that such modifications belong to the scope of the present invention.

What is claimed is:

1. A stack of a fuel cell, comprising:
an electricity generating unit including a plurality of stacked unit cells; and
a cooling unit supplying each of the unit cells with a cooling medium, wherein the amount of cooling medium supplied to each unit cell varies depending on the position of the unit cell within the stack.

2. The stack of claim 1, wherein the amount of cooling medium supplied to the unit cells increases at the unit cells toward a central portion of the stack.

3. The stack of claim 1, wherein the cooling medium is air or water.

4. A stack of a fuel cell comprising:
a plurality of stacked electricity generators, each including separators disposed at both sides of a membrane-electrode assembly;
a plurality of heat releasing means for releasing heat generated from the electricity generators, wherein the heat releasing means have different heat release rates depending on their positions with respect to the electricity generators in the stack.

5. The stack of claim 4, wherein the heat release rates of the heat releasing means increase toward a central portion of the stack.

6. The stack of claim 5, wherein the heat releasing means comprise flow passages which are formed in the separators and through which a coolant flows and the sizes of the flow passages increase toward the central portion of the stack.

7. The stack of claim 5, wherein the heat releasing means comprise cooling plates disposed between each of the electricity generators, wherein the cooling plates have holes through which coolant flows and the sizes of the holes are larger toward a central portion of the stack compared to an outer portion of the stack.

8. The stack of claim 5, wherein the heat releasing means comprise flow grooves which are formed in separators at portions corresponding to non-active regions of the corresponding membrane-electrode assembly and through which coolant flows, wherein the sizes of the flow grooves increase toward the central portion of the stack.

9. The stack of claim 5, wherein the heat releasing means comprise heat conductive media which are attached to the separators and which have higher heat-conductivity than the heat capacities of the separators, wherein the size of each of the heat conductive media increases toward the central portion of the stack.

10. The stack of claim 5, wherein the heat releasing means comprise one or more fans directing cooling air to the electricity generators, wherein a higher amount of cooling air is provided toward the central portion of the stack.

11. The stack of claim 4, wherein the separators disposed at the outermost sides of the stack comprise end plates.

12. The stack of claim 4, wherein the coolant comprises cooling air or cooling water.

13. A stack of a fuel cell comprising a plurality of stacked electricity generators, each including separators disposed at both sides of a membrane-electrode assembly, wherein each separator defines one or more flow passages through which a coolant may flow and the sizes of the flow passages increase toward a central portion of the stack.

14. The stack of claim 13, wherein the flow passages are formed at side surfaces of the separators.

15. The stack of claim 14, wherein each of the flow passages has a cross section in the shape of a channel or hole.

16. The stack of claim 15, wherein the flow passages are formed in the shape of channels at a surface of a first separator and at a surface of a second separator adjacent the first separator, wherein the channels of each pair of adjacent separators together form a hole.

17. The stack of claim 16, wherein the holes have cross sections in the shape of tetragons or circles.

18. The stack of claim 13, wherein the separators disposed at the outermost sides of the stack comprise end plates.

19. The stack of claim 13, wherein the coolant comprises cooling air or cooling water.

20. A stack of a fuel cell comprising:
one or more stacked electricity generators including separators disposed at both sides of a membrane-electrode assembly; and
cooling plates disposed between the electricity generators and defining holes through which a coolant may flow, wherein the sizes of the holes in the cooling plates increase toward a central portion of the stack.

21. The stack of claim 20, wherein each hole has a cross section in the shape of a tetragon or circle.

22. The stack of claim 20, wherein the separators disposed at the outermost sides of the stack comprise end plates.

23. The stack of claim 20, wherein the coolant comprises cooling air or cooling water.

24. A stack of a fuel cell comprising:
a plurality of stacked electricity generators, each including separators disposed at both sides of a membrane-electrode assembly;
a plurality of flow grooves defined by the separators and through which a coolant may flow, wherein the flow grooves are located at portions of the separators corresponding to non-active regions of the membrane-electrode assembly and the sizes of the flow grooves increase toward a central portion of the stack.

25. The stack of claim 24, wherein the separators and membrane-electrode assemblies are adhered to one another such that the flow grooves form flow passages.

26. The stack of claim 25, wherein the flow grooves are formed in regions of the separators away from regions where hydrogen or air is supplied.

27. The stack of claim 24, wherein the separators disposed at the outermost sides of the stack comprise end plates.

28. The stack of claim 24, wherein the coolant comprises cooling air or cooling water.

29. A stack of a fuel cell comprising:
a plurality of stacked electricity generators, each including separators disposed at both sides of a membrane-electrode assembly; and
a heat conductive medium associated with each of the plurality of electricity generators, wherein the heat conductive media have heat-conductivity higher than that of the separators, and the sizes of the heat conductive media increase toward a central portion of the stack.

30. The stack of claim 29, wherein the heat conductive media comprise plates made of a metal selected from aluminum, copper, and iron.

31. The stack of claim 30, wherein each plate is attached to one side surface of a separator.

32. The stack of claim 30, wherein the plates further comprise one or more holes through which a coolant may flow.

33. The stack of claim 32, wherein the sizes of the holes are larger for the plates located toward a central portion of the stack compared to the holes for the plates located toward the ends of the stack.

34. The stack of claim 33, wherein each hole is formed in the shape of a channel.

35. The stack of claim 29, wherein the separators disposed at the outermost sides of the stack comprise end plates.

36. The stack of claim 29, wherein the coolant comprises cooling air or cooling water.

37. A stack of a fuel cell comprising:
a plurality of stacked electricity generators, each including separators disposed at both sides of a membrane-electrode assembly; and
a plurality of fans for directing cooling air to the electricity generators, wherein one or more fans located toward a central portion of the stack direct a higher flow of cooling air compared to the one or more fans located a the end portions of the stack.

38. The stack of claim 37 further comprising a housing constituting an external frame of the stack, wherein the housing holds the plurality of fans.

39. The stack of claim 37, wherein the separators disposed at the outermost sides of the stack comprise end plates.

40. The stack of claim 37, wherein the coolant comprises cooling air or cooling water.

41. A fuel cell system comprising:
a stack comprising a plurality of electricity generators, each including separators disposed at both sides of a membrane-electrode assembly;
a fuel supply unit for supplying a hydrogen-containing fuel to the stack;
an oxygen supply unit for supplying oxygen to the electricity generators; and
heat release means associated with a plurality of the electricity generators for removing heat from the associated electricity generators, wherein the amounts of heat removed by the heat releasing means vary depending on the location of the associated electricity generators within the stack.

42. The fuel cell system of claim 41 wherein higher amounts of heat are removed by the heat releasing means located toward a central portion of the stack.

43. The fuel cell system of claim 42 further comprising a coolant supply unit for supplying a coolant to the heat releasing means.

44. The fuel cell system of claim 43, wherein the coolant is selected from air and water.

45. The fuel cell system of claim 43, wherein higher amounts of coolant are supplied to the heat releasing means of the electricity generators located toward the central portion of the stack.

46. The fuel cell system of claim 43, wherein the separators define a plurality of flow passages through which the coolant flows, and the sizes of the flow passages increase toward the central portion of the stack.

47. The fuel cell system of claim 42, wherein the heat releasing means comprise cooling plates disposed between the electricity generators.

48. The fuel cell system of claim 47, wherein the cooling plates further define holes through which a coolant may flow, and the sizes of the holes are larger for the cooling plates located toward the central portion of the stack.

49. The fuel cell system of claim 42, wherein the heat releasing means comprise flow grooves formed on the separators at positions corresponding to non-active regions of the membrane-electrode assembly, and through which a coolant may flow, wherein the sizes of the grooves are larger for the separators located toward the central portion of the stack.

50. The fuel cell system of claim 42, wherein the heat releasing means comprise a plurality of heat conductive media attached to the separators and with heat conductivities higher than those of the separators, and the sizes of the heat conductive media increase toward the central portion of the stack.

51. The fuel cell system of claim 42, wherein the heat releasing means comprise a plurality of fans for directing cooling air to the electricity generators, wherein one or more of the fans directed to the electricity generators located toward the central portion of the stack direct a higher flow of cooling air than the one or more fans located toward the ends of the stack.

52. The fuel cell system of claim 41 further comprising a reformer disposed between the stack and the fuel supply unit.

53. The fuel cell system of claim 41, wherein the electricity generators are selected from a polymer electrolyte membrane electricity generators and direct methanol electricity generators.
